(19) United States
(12) Patent Application Publication
(10) Pub. No.: US 2006/0188698 A1
(43) Pub. Date: Aug. 24, 2006

(54) Magnesium body with armoring

(75) Inventors: Marcellinus Ibe, Wetzlar (DE); Harry Ferber, Solms (DE); Kai-Uwe Schierz, Braunfels (DE)

Correspondence Address: FOLEY AND LARDNER LLP;SUITE 500, 3000 K STREET NW, WASHINGTON, DC, 20007, US

(73) Assignee: LEICA CAMERA AG

(21) Appl. No.: 11/098,381

(22) Filed: Apr. 5, 2005

(30) Foreign Application Priority Data
Feb. 18, 2005 (DE) 20 2005 002 716.2

(51) Int. Cl. B32B 15/04

(52) U.S. Cl. 428/192; 428/457

(57) ABSTRACT

A magnesium body is provided with an armoring by connecting a film tape via a first adhesive layer to the magnesium body and via a second adhesive layer to the armoring. The bond strength of the first adhesive layer preferable is lower than the bond strength of the second adhesive layer.

The innovation relates to a magnesium body with armoring.

Reference to a magnesium body is intended to comprehend, in particular, telescope bodies and camera casings. Apparatus casings made of magnesium are lightweight and dimensionally stable. They have the disadvantage, however, that magnesium surfaces are highly susceptible to corrosion.

To protect against corrosion, surfaces are therefore provided, for example, with a ceramic coat of magnesium oxide. The coat thickness is approximately 20 μm and is therefore very stable. Producing the coat, however, is relatively expensive. A different surface protection can be produced by means of a passivating process, that gives a coat thickness only of 1 μm, so that this protective coat is highly sensitive. To improve the protection further it is possible in addition to apply a protective lacquer by cathodic dip coating.

Apparatus casings are normally further provided with armoring, which provides a better handling grip, increases impact resistance and allows special design. The armoring also, in particular, covers assembly openings and connecting means to the components disposed within the casing. The armoring is normally adhered to the casing or put on elastically and possibly shrunk in addition. Such armoring is also applied to magnesium bodies.

For repair operations it is frequently necessary to expose the openings and, for example, screw heads covered by the armoring, so that the armoring has to be removed from the magnesium body. For this purpose, conventionally, the armoring is cut open with a sharp and pointed tool, lifted and then torn away from the magnesium body. In the course of this operation it is frequently the case that the oxidation protection coat applied to the magnesium body is damaged, thereby considerably increasing the susceptible to corrosion and meaning, therefore, that in the majority of cases it is necessary to replace the entire magnesium body. This leads to high servicing costs.

The object on which the innovation was based was therefore to specify a means of attaching the armoring to magnesium bodies that prevents damage to the oxidation protection coat when the armoring is removed.

This object is achieved in accordance with the innovation by connecting a film tape via a first adhesive layer to the magnesium body and via a second adhesive layer to the armoring. The film tape forms an intermediate layer between magnesium body and outer armoring. The intermediate layer is applied principally in those regions of the magnesium body at which edge regions of the armoring are adhered. It may be advantageous here for the film tape to be stuck to additional support points on the surface of the magnesium body.

With advantage, the film tape may itself be formed as a single-sided adhesive tape. As material for the film tape it is advantageous to select a plastic, with the provision of a woven insert also being possible. A film tape of this kind can be adhered without creases even to curved surfaces. When the armoring is cut in order to detach it, a marked resistance is felt when the cutter meets the film tape. Thereafter, the cutting tool can be guided in a scraping manner on the film tape, in order to allow part of the armoring to be lifted. This part can then be gripped for the purpose of further, tearing removal. One suitable adhesive tape is known under the trade name Macal 9800 S.

The bond strength of the first adhesive layer should preferably be lower than the bond strength of the second adhesive layer, the intention being that the lower bond strength should be less than 1 N/mm. The abovementioned adhesive tape has such a bond strength. An adhesive layer with a stronger bond strength can be produced, for example, using the adhesive known under the trade name Loctite 406.

The aforementioned bond strength distribution has the advantage that, when the armoring is removed with tearing, the film tape is torn off as well. If, nevertheless, individual regions of film tape remain attached to the magnesium body, they can be scraped off, owing to the low bond strength of the adhesive layer, using a blunt instrument, without damaging the oxidation protection coat, to form an area of attack for the purpose of complete removal.

As well as the tactile perception of the film tape having been arrived at, the visual perception of the necessary depth of cut for the detachment of the armoring, as well, is made possible by providing the film tape with appropriate coloring. This further reduces the risk of damaging the oxidation protection coat. Since the armorings frequently have a dark color, a light color of the film tape is particularly advantageous for the recognition of the necessary depth of cut.

The drawing depicts one exemplary embodiment of the innovation in diagrammatic form. In the drawing

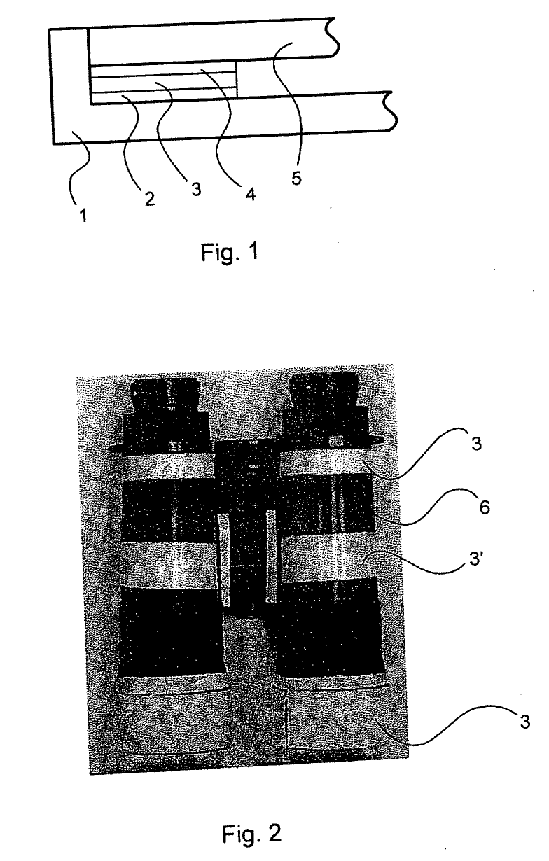

FIG. 1 shows a cross section through the magnesium body with armoring and

FIG. 2 shows a plan view of a field-glass body with film tapes.

The cross section depicted in FIG. 1 shows by way of example a magnesium body 1, a first adhesive layer 2, a film tape 3, a second adhesive layer 4, and armoring 5.

FIG. 2 depicts, as one exemplary embodiment, a binoculars body 6 with adhered film tapes 3. The film tape 3′ is provided as a support point. The light color of the film tapes also contrasts markedly with the darker color of the magnesium body. The region to be provided with the second adhesive layer is thus clearly delimited. Moreover, it is easier to find remaining film-tape sections when the armoring is detached.

The armoring, which is not shown here, is adhered to the film tapes. The prefabricated armoring is configured in terms of its three-dimensional form and through its material in such a way that it lies fittingly on the surface of the binoculars body 6. The film tapes 3 are sufficiently thin that the shape-conforming lie of the armoring is not hindered.

1) Magnesium body with armoring, characterized in that a film tape (3) is connected via a first adhesive layer (2) to the magnesium body (1) and via a second adhesive layer (4) to the armoring (5).

2) Magnesium body according to claim 1, characterized in that the film tape (3) is bonded to the magnesium body (1) at regions to which edges of the armoring (5) are assigned.

3) Magnesium body according to claim 2, characterized in that a film tape (3′) is bonded to the magnesium body (1) at additional support points.

4) Magnesium body according to claim 1, characterized in that the film tape (3) is the carrier of the first adhesive layer (2).

5) Magnesium body according to claim 1, characterized in that the film tape (3) is composed of plastic.

6) Magnesium body according to claim 5, characterized in that the film tape (3) is provided with a woven insert.

7) Magnesium body according to claim 1, characterized in that the bond strength of the first adhesive layer (2) is lower than the bond strength of the second adhesive layer (4).

8) Magnesium body according to claim 7, characterized in that the bond strength of the first adhesive layer (2) is less than 1 N/mm.

9) Magnesium body according to claim 1, characterized in that at least the surface of the film tape (3) that faces the armoring (5) has a color different from the color of the magnesium body (1).

10) Magnesium body according to claim 9, characterized in that the film tape (3) has a light color.
